(19) United States
(12) Patent Application Publication
(10) Pub. No.: US 2026/0257539 A1
(43) Pub. Date: Sep. 3, 2026

(54) DIMMABLE VISOR ASSEMBLY

(71) Applicant: Gentex Corporation, Zeeland, MI (US)

(72) Inventors: Jacob R. Groenendyk, Jenison, MI (US); Aaron Koerth, Hudsonville, MI (US); Eric S. Lundy, Holland, MI (US); Nigel T. Lock, Holland, MI (US); Peter T. Kantola, Ravenna, MI (US)

(21) Appl. No.: 19/555,108

(22) Filed: Mar. 3, 2026

Related U.S. Application Data
(60) Provisional application No. 63/765,871, filed on Mar. 3, 2025.

(51) Int. Cl. B60J 3/04

(52) U.S. Cl. CPC B60J 3/04

(57) ABSTRACT

A dimmable visor assembly includes a connector arm configured to couple to a vehicle and a visor body that includes a header that defines a top side of the visor body and an electro-optic shade that extends from the header and defines a bottom side of the visor body. The header is rotatably coupled to the connector arm proximate the top side. The electro-optic shade is operable between a clear state and a darkened state. A mirror is disposed on the header and extends between the top side of the visor body and the electro-optic shade. One or more light units are disposed on the header of the visor body. A glass layer lines the electro-optic shade.

### CROSS-REFERENCE TO RELATED APPLICATION

This application claims priority under 35 U.S.C. § 119(e) upon U.S. Provisional Patent Application No. 63/765,871, filed on Mar. 3, 2025, entitled “DIMMABLE VISOR ASSEMBLY,” the disclosure of which is hereby incorporated herein by reference in its entirety.

### FIELD OF THE DISCLOSURE

The present disclosure generally relates to a visor assembly for a vehicle, and more particularly to an electro-optic visor assembly for a vehicle.

### SUMMARY OF THE DISCLOSURE

According to one aspect of the present disclosure, dimmable visor assembly includes a connector arm configured to couple to a vehicle and a visor body that includes a header that defines a top side of the visor body and an electro-optic shade that extends from the header and defines a bottom side of the visor body. The header is rotatably coupled to the connector arm proximate the top side. The electro-optic shade is operable between a clear state and a darkened state. A mirror is disposed on the header and extends between the top side of the visor body and the electro-optic shade. One or more light units are disposed on the header of the visor body. A glass layer lines the electro-optic shade.

According to another aspect of the present disclosure, visor assembly for a vehicle includes a connector arm and a visor body. The visor body includes an opaque header rotatably coupled to the connector arm. The opaque header has an upper side, a lower side, and a first surface. An electro-optic shade extends from the lower side of the opaque header. The electro-optic shade is operable between a clear state and a darkened state and has a second surface. The first surface and the second surface are lined with a glass layer. A cover plate is operably coupled to the visor body and selectively covers a mirror of the visor assembly. At least one light unit is disposed laterally adjacent to the mirror when the cover plate extends along the first surface.

According to another aspect of the present disclosure, a visor assembly for a vehicle includes a visor body configured to be coupled to the vehicle. The visor body includes a header that has an upper side and a lower side. The header includes a mirror configured to face a user with the visor body in a deployed position. An electro-optic shade is coupled to the header proximate the lower side. The electro-optic shade is operable between a clear state and a darkened state. A single, monolithic glass layer lines each of the header and the electro-optic shade. The single, monolithic glass layer has a substantially planar and continuous surface that defines an outer surface of the visor body. The outer surface is configured to face the user in the deployed position of the visor body.

The glass-incorporated configuration of the dimmable visor assembly shown and described herein enables new and enhanced design features for the dimmable visor assembly. For example, the dimmable visor assembly includes an electro-optic shade with a variable light transmissivity and a header that may include one or more vanity lights, a mirror, or a combination thereof. In configurations where the dimmable visor assembly includes one or more vanity lights, the one or more vanity lights may be conveniently hidden or concealed by a glass layer and/or a partially reflective or partially transparent coating. In configurations where the dimmable visor assembly includes a mirror, the mirror may be similarly concealed at least in an activated or non-reflective state. The mirror may be operated automatically by a controller and/or manually by a user between the non-reflective state and a reflective state. Capacitive touch button circuitry may be provided under the glass layer to allow a user to control various vehicle systems and/or components by engaging the visor body proximate one or more button regions. Furthermore, the glass layer lining the visor body is substantially smooth, facilitating, among other things, an enhanced convenience with respect to cleaning the dimmable visor assembly.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front elevational view of a dimmable visor assembly of the present disclosure, with a cover plate in a closed position;

FIG. 2A is a front elevational view of a dimmable visor assembly of the present disclosure, with a cover plate in an open position to expose a mirror disposed on a header between a pair of light units;

FIG. 2B is a front elevational view of a dimmable visor assembly of the present disclosure, with a cover plate in an open position to expose a mirror and a pair of light units surrounded by the mirror; and

FIG. 3 is a rear elevational view of a dimmable visor assembly of the present disclosure.

### DETAILED DESCRIPTION

The present illustrated embodiments reside primarily in combinations of method steps and apparatus components related to a dimmable visor assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

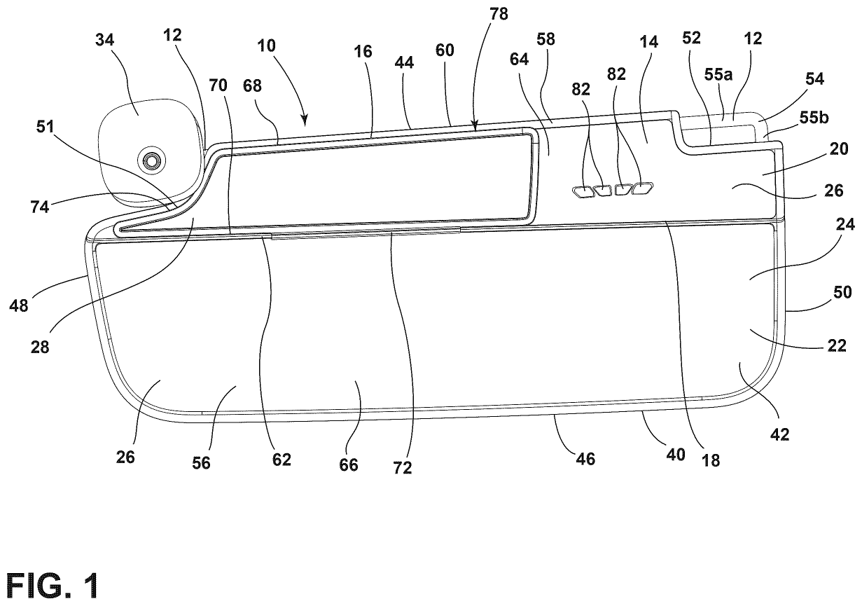

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to a surface of the device closest to an intended viewer, and the term “rear” shall refer to a surface of the device furthest from the intended viewer. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIGS. 1-3, reference numeral 10 generally designates a dimmable visor assembly for a vehicle 11. The dimmable visor assembly 10 includes a connector arm 12 and an opaque header 14 rotatably coupled to the connector arm 12. The header 14 has an upper side 16, a lower side 18, and a first surface 20. An electro-optic shade 22 extends from the lower side 18 of the header 14 and is operable between a clear state and a darkened state. The electro-optic shade 22 has a second surface 24. The first surface 20 and the second surface 24 are lined with a glass layer 26. The dimmable visor assembly 10 further includes a cover plate 28 that is rotatable relative to the header 14 to selectively cover a mirror 30. At least one light unit 32 is disposed laterally adjacent to the mirror 30 when the cover plate 28 extends along the first surface 20.

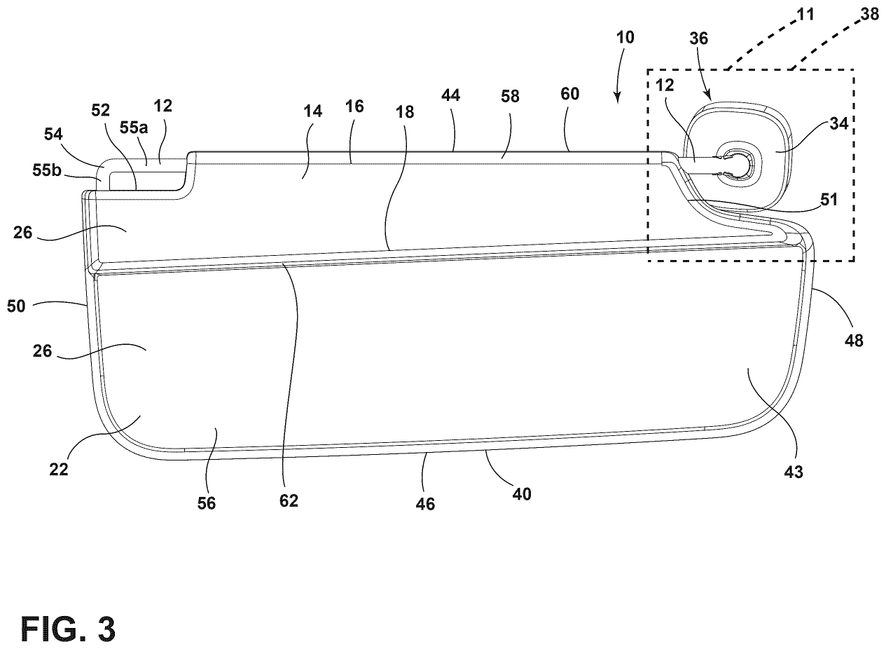

With reference to FIGS. 1 and 3, the dimmable visor assembly 10 includes the connector arm 12. The connector arm 12 may be pivotally coupled to a connector piece 34 configured to couple to the vehicle 11 at an installation location 36. In some configurations, the installation location 36 may be situated within the vehicle 11 (e.g., within or otherwise proximate a vehicle interior or passenger compartment). For example, the connector piece 34 may be disposed on or within a headliner 38 of the vehicle 11. According to some aspects, the connector arm 12 may be fixedly secured to the connector piece 34, and the connector piece 34 may be pivotal relative to the vehicle 11 at the installation location 36. The vehicle 11 may be a motor vehicle such as a wheeled motor vehicle with an internal combustion engine, an electric battery powered motor, or a hybrid system that has a combination of an internal combustion engine and an electric battery, for example.

According to various implementations, the dimmable visor assembly 10 includes a visor body 40. As demonstrated in FIGS. 1 and 3, the visor body 40 has a front surface 42 and a rear surface 43 that extend between top and bottom sides 44, 46 of the visor body 40 and between first and second ends 48, 50 of the visor body 40. Here, the top and bottom sides 44, 46 of the visor body 40 extend between the first and second ends 48, 50 of the visor body 40. The visor body 40 includes the header 14 with the upper side 16 and the lower side 18 and the electro-optic shade 22 that extends from the lower side 18 of the header 14. According to some aspects, the upper side 16 of the header 14 may define the top side 44 of the visor body 40, and the electro-optic shade 22 may define the bottom side 46 of the visor body 40. The header 14 may have a reduced optical transmissivity. For example, the header 14 may be opaque so as to conceal components therein, such as a pivot mechanism of the visor body 40, an electrical circuit board, one or more capacitive-touch switches, a combination thereof, and/or one or more other components. In some configurations, a partially reflective and/or partially transparent coating (“transflective coating”) may line the header 14 so as to at least partially conceal the components therein. Furthermore, the electro-optic shade 22 may be transparent, translucent, or substantially opaque, according to various instances.

Further referring to FIGS. 1 and 3, the connector arm 12 may extend at least partially away from the connector piece 34. Accordingly, with the connector piece 34 coupled to the vehicle 11 at the installation location 36, the connector arm 12 may extend at least partially away from the vehicle 11 at the installation location 36. As illustrated, the header 14 of the visor body 40 defines a concave arcuate corner 51 (hereinafter “first arcuate corner”) proximate the top side 44 of the visor body 40 and the first end 48 of the visor body 40. Here, the connector arm 12 extends into the header 14 at the first arcuate corner 51 and may be rotatably coupled to the header 14 along the top side 44 of the visor body 40 such that the visor body 40 is configured to be rotatable relative to the vehicle 11, at least at the installation location 36, between a stowed position and a deployed position. The front surface 42 of the visor body 40 is typically a user-facing surface when the visor body 40 is in the deployed position. The rear surface 43 may have an identical, substantially similar, or different construction relative to the front surface 42.

According to various implementations, the connector arm 12 may extend within the visor body 40 proximate the top side 44 thereof. As demonstrated in FIG. 1, the header 14 of the visor body 40 may define an indent 52 proximate the top side 44 and the second end 50, and a section 54 (hereinafter “exposed section”) of the connector arm 12 may be exposed (e.g., situated external to the visor body 40) at the indent 52. This exposed section 54 of the connector arm 12 may, for example, be configured to selectively couple to a visor receptacle provided by the vehicle 11 to further secure the visor body 40 to the vehicle 11. The exposed section 54 may include a first portion 55a that protrudes from the visor body 40 at the indent 52 toward the second end 50 and a second portion 55b that protrudes from the visor body 40 at the indent 52 toward the top side 44, intersecting with the first portion 55a proximate the top side 44. According to some aspects, the exposed section 54 may be an end section of the connector arm 12. The connector arm 12 may be interrupted along the top side 44 such that the exposed section 54 is not integral with a portion of the connector arm 12 that extends from the connector piece 34, enabling the visor body 40 to rotate relative to the portion of the connector arm 12 connected to the connector piece 34. It is contemplated that the connection between the connector arm 12 and the header 14 may be alternatively configured in other implementations. Furthermore, the dimmable visor assembly 10 may be coupled to the vehicle 11 via a wide variety of configurations, according to various aspects.

With reference again to FIGS. 1 and 3, the electro-optic shade 22 of the visor body 40 extends from the lower side 18 of the header 14. The electro-optic shade 22 includes an electro-optic panel 56 that is operable between a clear state and an altered or darkened state that may result from an electro-optic medium therein being subjected to an electric field, current, or charge. In one example, the electro-optic panel 56 includes a pair of glass substrates, a pair of electrically conductive layers disposed between the pair of glass substrates, and an electrolyte layer disposed between the pair of electrically conductive layers. Each of the electrically conductive layers may include a transparent conductive oxide, such as indium tin oxide, for example. The pair of glass substrates may be substituted with a pair of plastic substrates in some configurations. In other configurations, the pair of glass substrates of the electro-optic shade 22 may be disposed between an outer pair of glass substrates or layers. According to some aspects, the electro-optic shade 22 in the clear state may be operated into the darkened state or vice versa in response to an electrical activation of the electro-optic panel 56. The electrical activation of the electro-optic shade 22 from the clear state to the darkened state or vice versa may, for instance, be controlled automatically by a controller of the vehicle 11 and/or manually by a user through a user interface.

In some configurations, the visor body 40 may include a structural frame 58 that extends along a perimeter 60 of the visor body 40 and the periphery of each of the header 14 and the electro-optic shade 22. As illustrated in FIGS. 1 and 3, the header 14 and the electro-optic shade 22 are additionally separated by an intermediate portion 62 of the frame 58 that extends between the first end 48 of the visor body 40 and the second end 50 of the visor body 40. The frame 58 may be made of a material including but not limited to a metal, plastic, or glass material. In other configurations, the visor body 40 may be frameless, and the header 14 and the electro-optic shade 22 may be directly coupled. Alternatively, the frame 58 may only extend along the perimeter 60 of the visor body 40 or between the header 14 and the electro-optic shade 22. The frame 58 may extend along the header 14 at the first arcuate corner 51 so as to substantially match the curvature of the header 14 at least at the first arcuate corner 51.

With reference to FIG. 1, the front surface 42 of the visor body 40 may be lined with the glass layer 26, where the glass layer 26 is typically planar. According to some aspects, the glass layer 26 may define the front surface 42. The glass layer 26 may, for example, include a first glass overlay 64 lining the first surface 20 of the header 14 and a second glass overlay 66 lining the second surface 24 of the electro-optic shade 22. Here, it is contemplated that the first glass overlay 64 may alternatively define the first surface 20 of the header 14, and the second glass overlay 66 may alternatively define the second surface 24 of the electro-optic shade 22. As illustrated, the first glass overlay 64 is separated from the second glass overlay 66 by the intermediate portion 62 of the frame 58, and the first glass overlay 64 is substantially flush with the second glass overlay 66. In some configurations, the rear surface 43 (FIG. 3) of the visor body 40 may be lined with or may be defined by another glass layer 26 which may have a substantially similar construction relative to the glass layer 26 lining or defining the front surface 42 of the visor body 40.

In configurations where the frame 58 does not include the intermediate portion 62, the first glass overlay 64 may be in contact with the second glass overlay 66. In some instances, the glass layer 26 may omit the first glass overlay 64. Alternatively, the first and second glass overlays 64, 66 may be portions of a single, monolithic glass overlay that is continuous within the perimeter 60 of the visor body 40. Here, the glass layer 26 may include a substantially planar and continuous surface that defines an outer surface of the visor body 40 within the perimeter 60. In this configuration, the outer surface may be the front surface 42 of the visor body 40 and may be configured to face a user when the visor body 40 is in the deployed position. It is also contemplated that the second glass overlay 66 may be one of the pair of glass substrates of the electro-optic panel 56. In configurations where the glass layer 26 is a single, monolithic glass overlay, one of the pair of glass substrates may also be the first glass overlay 64. According to some aspects, the first and second glass overlays 64, 66 may be laterally offset. For example, the electro-optic shade 22 may be thinner or thicker than the header 14, and the second glass overlay 66 may consequently be laterally offset from the first glass overlay 64. The glass layer 26 is made of a glass material that may be energy-absorbing to align the use and function of the dimmable visor assembly 10 with current technology and regulatory frameworks.

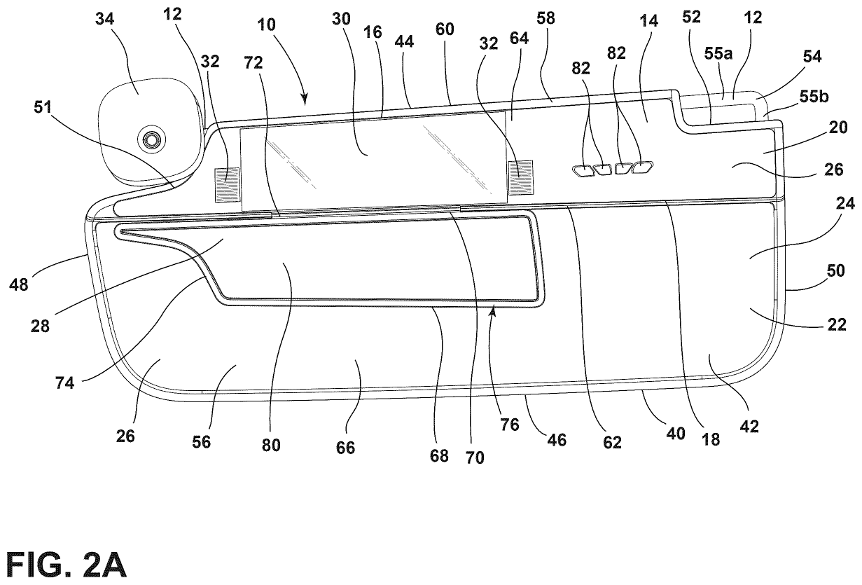

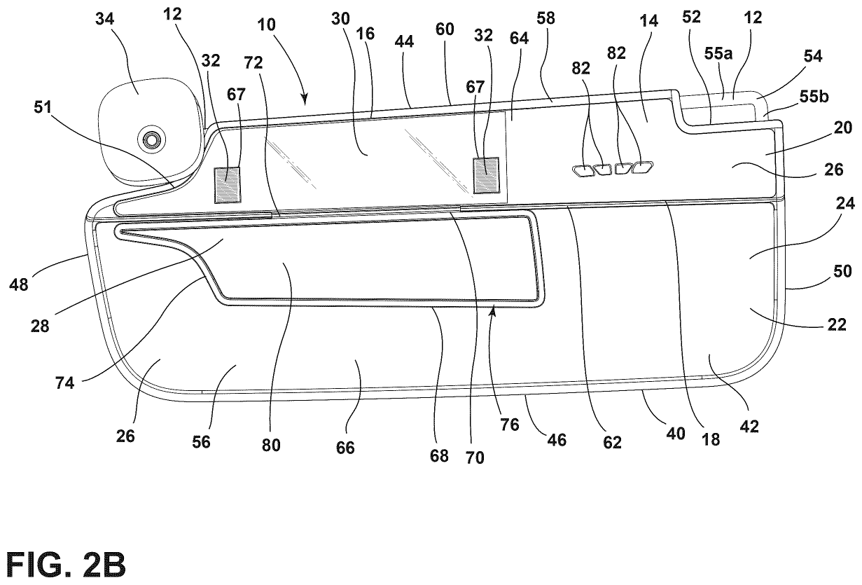

With reference now to FIG. 2A, the mirror 30 is disposed within the header 14 of the visor body 40 proximate the top side 44. As illustrated, the mirror 30 has a rectangular shape and is substantially flush with the first surface 20 of the header 14. Here, the mirror 30 extends between the upper side 16 of the header 14 and the lower side 18 of the header 14. In alternative configurations, the mirror 30 may protrude from the first surface 20 of the header 14. The mirror 30 is typically overlaid by the first glass overlay 64 such that the first glass overlay 64 has a substantially planar surface. According to some aspects, the mirror 30 may be disposed on the first glass overlay 64. In some configurations, the first glass overlay 64 may alternatively define an aperture corresponding to the shape of the mirror 30 such that the mirror 30 is disposed within the aperture and is surrounded by the first glass overlay 64. The mirror 30 may include a liquid crystal display, polarizing filters, a transflective coating, and/or backlighting and may be operable between an inactivated state and an activated state. Here, the mirror 30 may be substantially non-reflective in the inactivated state and substantially reflective in the activated state. In configurations where the dimmable visor assembly 10 includes a transflective coating, the transflective coating may be disposed between the mirror 30 and the first glass overlay 64 or on the first glass overlay 64 such that the mirror 30 is at least partially hidden and/or inconspicuous in at least the inactivated state. The mirror 30 may alternatively be a reflective or transflective coating or layer that overlays the first glass overlay 64 or is disposed between the first glass overlay 64 and the header 14. In one exemplary configuration where the mirror 30 is operable between the inactivated state and the activated state, the dimmable visor assembly 10 does not include the cover plate 28. The operation of the mirror 30 between the inactivated state and the activated state may be controlled automatically by a controller of the vehicle 11 based on time, brightness, location, weather, and/or other conditions, for example. Additionally or alternatively, activation of the mirror 30 may be controlled manually by a user through a user interface.

As further illustrated in FIG. 2A, the mirror 30 is disposed between a pair of light units 32 disposed in the header 14 of the visor body 40. Particularly, the pair of light units 32 are disposed within the header 14 and overlaid by the first glass overlay 64. The pair of light units 32 are operable between an off state and an illuminated state. In the illuminated state, the pair of light units 32 may emit light. The light emitted by the pair of light units 32 may be diffused, which may, for example, be accomplished with frosted light covers, translucent covers, or other light diffusers disposed on the pair of light units 32 and/or between the pair of light units 32 and the first glass overlay 64. In some instances, the light emitted by the pair of light units 32 may be diffused by the first glass overlay 64. For example, one or more portions of the first glass overlay 64 over the pair of light units 32 may be laser etched to create a light-diffusive effect. Alternatively, a diffusive material may coat or may be printed onto or otherwise provided by one or more portions of the first glass overlay 64 over the pair of light units 32. A transflective coating may be disposed between the pair of light units 32 and the first glass overlay 64 or on the first glass overlay 64 such that the pair of light units 32 are at least partially hidden and/or inconspicuous in the off state. It is contemplated that the dimmable visor assembly 10 may include a single light unit 32 or no light units 32 in some configurations. Alternatively, the dimmable visor assembly 10 may include more than two light units 32. According to some aspects, the first glass overlay 64 may define an aperture corresponding to each of the pair of light units 32. Here, the pair of light units 32 may be disposed respectively within the apertures of the first glass overlay 64. It is also contemplated that the pair of light units 32 may extend from and/or be disposed on the first glass overlay 64.

With reference now to FIG. 2B, the mirror 30 may extend to the first end 48 of the visor body 40 such that the shape of the mirror 30 substantially corresponds to or matches the curvature of the first arcuate corner 51 of the header 14, thereby maximizing the size and coverage of the mirror 30. Here, the mirror 30 further defines a pair of openings 67. Each of the pair of openings 67 is configured to receive one of the pair of light units 32. Accordingly, each of the pair of light units 32 is surrounded by the mirror 30. It is contemplated that each of the pair of light units 32 may alternatively be disposed on the mirror 30 or overlaid by the mirror 30. In some configurations, the header 14 of the visor body 40 may further include an auxiliary light, such as a backlight, for example. This auxiliary light may selectively illuminate an airbag warning sign or another sign or indicia defined by the header 14, disposed on the header 14, disposed on the auxiliary light, and/or disposed on the first glass overlay 64. In such configurations, the auxiliary light may be incorporated into the header 14 in a configuration similar to the pair of light units 32, described above. The pair of light units 32, the auxiliary light, or a combination thereof may, for example, be activated in response to the visor body 40 being pivoted from the stowed position to the deployed position, in response to the cover plate 28 being pivoted from a closed position 78 to an open position 76, and/or in response to another user interaction with the visor body 40.

With reference to FIGS. 1 and 2A, the dimmable visor assembly 10 additionally includes the cover plate 28 that is operably coupled to the visor body 40. As illustrated, the cover plate 28 is rotatably coupled to the visor body 40 and is located proximate the first end 48 and proximate the top side 44 at least in the closed position 78. Particularly, the cover plate 28 has a first side 68 and a second side 70 rotatably coupled to the intermediate portion 62 of the frame 58 via a hinge 72. The cover plate 28 may have, at least in part, a rectangular shape with a second concave arcuate corner 74 that corresponds to or matches the curvature of the first arcuate corner 51 of the header 14. The second arcuate corner 74 allows the cover plate 28 to be positioned close to a section of the connector arm 12 that extends into the header 14 at the first arcuate corner 51 while maximizing the size and coverage of the cover plate 28. The cover plate 28 is pivotal between the open position 76 (FIG. 2A) and the closed position 78 (FIG. 1). As illustrated, the cover plate 28 extends along the electro-optic shade 22 in the open position 76. In the closed position 78, the cover plate 28 extends along the header 14 and covers the mirror 30, and the second arcuate corner 74 of the cover plate 28 aligns with the first arcuate corner 51 of the header 14.

According to various implementations, the second side 70 of the cover plate 28 may be coupled to another location on the visor body 40. For example, the second side 70 of the cover plate 28 may be rotatably coupled to the header 14 or the electro-optic shade 22. Additionally or alternatively, the cover plate 28 may be operably coupled to the visor body 40 via at least one magnet. In some configurations, the mirror 30 may alternatively be disposed on or within an inner surface 80 of the cover plate 28, where the mirror 30 faces toward the visor body 40 when the cover plate 28 is in the closed position 78 and faces away from the visor body 40 when the cover plate 28 is in the open position 76. It is contemplated that configurations in which the mirror 30 is disposed on or within the cover plate 28 may result in more convenient and more cost-effective manufacturing of the dimmable visor assembly 10.

It is contemplated that the first side 68 of the cover plate 28 may be in contact with the frame 58, in contact with the electro-optic shade 22, in contact with both the frame 58 and the electro-optic shade 22, or spaced from the electro-optic shade 22 and the frame 58 when the cover plate 28 is in the open position 76. In the closed position 78 of the cover plate 28, the first side 68 may be in contact with the frame 58, in contact with the header 14, in contact with both the frame 58 and the header 14, or spaced from the header 14 and the frame 58. The first side 68 of the cover plate 28 may be spaced from the visor body 40 in one or both of the open position 76 and the closed position 78 as a result of a detent projecting from the visor body 40 and/or the configuration of the hinge 72, for example. Notably, the cover plate 28 may include one or more magnets disposed on or within the cover plate 28. Here, the one or more magnets may be configured to be magnetically attracted to another magnet or a ferromagnetic material, for example, disposed on or within the visor body 40. In one exemplary configuration, a magnet is disposed on the cover plate 28, and a ferromagnetic tab is disposed within the header 14 such that the cover plate 28 is at least magnetically secured to the header 14 when in the closed position 78. The cover plate 28 may additionally be biased toward the closed position 78 and/or the open position 76 in some configurations. According to one aspect, the hinge 72 of the cover plate 28 may include a biasing mechanism, such as a spring, configured to urge the cover plate 28 into the open position 76. In alternative configurations, a ferromagnetic material may be disposed within the cover plate 28, and one or more magnets may be disposed within the visor body 40 to provide magnetic attraction between the visor body 40 and the cover plate 28 at least in the closed position 78.

According to various aspects, the orientation of the cover plate 28 may control the operation of the pair of light units 32 and/or the mirror 30. In one example, a reed switch is positioned on or within the header 14 and overlaid by the mirror 30, and one or more magnets are provided on or within the cover plate 28. Here, with the cover plate 28 in the closed position 78, the one or more magnets interact with the reed switch such that the pair of light units 32 are in the off state and/or the mirror 30 is in the inactivated state. With the cover plate 28 in the open position 76, the one or more magnets are separated from the reed switch, thereby operating the pair of light units 32 to the illuminated state and/or operating the mirror 30 to the activated state.

With further reference to FIGS. 1 and 2A, the first glass overlay 64 may define a plurality of touch-sensitive button regions 82. In some configurations, each of the plurality of button regions 82 includes capacitive touch circuitry configured to detect when a user touches the button region 82 and activate or control a system or component within the vehicle 11 in response to a determination that the user has touched the button region 82. The system or component configured to be activated may be interior vehicle lighting, the electro-optic panel 56, the mirror 30, and/or the pair of light units 32, for example. In some instances, the plurality of button regions 82 may be visually delineated via etching, engraving, printed graphics overlaying or overlaid by the first glass overlay 64, backlighting, indentations in the first glass overlay 64, and/or other delineation features. Furthermore, the plurality of button regions 82 may include haptic, visual, and/or acoustic feedback features to indicate when one of the button regions 82 is in contact with a finger of the user or another external object, for instance. It is also contemplated that the first glass overlay 64 may define an aperture corresponding to at least one of the plurality of button regions 82. In such configurations, a physical button may be disposed within this aperture in at least one of the plurality of button regions 82. Accordingly, the user may physically push the at least one physical button and activate or control at least one system or component of the vehicle 11 via the at least one physical button.

The glass layer 26 of the dimmable visor assembly 10 advantageously provides a smooth glass finish along the front surface 42 of the visor body 40. As a result, the dimmable visor assembly 10 is easy to clean, provides an enhanced user interface, and may be easier to grip and operate between the stowed position and the deployed position, for example. The glass layer 26 of the visor body 40 may define features such as one or more touch-sensitive button regions 82 that allow a user to control various vehicular systems and/or components upon touching or otherwise engaging one of the button regions 82. The mirror 30 may be operable to a non-reflective state, reducing potential distractions for a driver of the vehicle 11 when the visor body 40 is in the deployed position and reducing or eliminating the need for the cover plate 28. The electro-optic shade 22 is also operable between the clear state and the darkened state, which may be desirable for adjusting the light transmissivity of the electro-optic shade 22 depending on conditions, such as brightness, location, weather, and/or other environmental or internal vehicle conditions. The dimmable visor assembly 10 also provides for enhanced and/or simplified manufacturability, especially in constructions where the mirror 30 is disposed on or within the cover plate 28 or where the glass layer 26 is a single, monolithic glass overlay.

It will be understood by one having ordinary skill in the art that construction of the described disclosure and other components is not limited to any specific material. Other exemplary embodiments of the disclosure disclosed herein may be formed from a wide variety of materials, unless described otherwise herein.

According to an aspect of the present disclosure, a dimmable visor assembly includes a connector arm configured to couple to a vehicle and a visor body that includes a header that defines a top side of the visor body and an electro-optic shade that extends from the header and defines a bottom side of the visor body. The header is rotatably coupled to the connector arm proximate the top side. The electro-optic shade is operable between a clear state and a darkened state. A mirror is disposed on the header and extends between the top side of the visor body and the electro-optic shade. One or more light units are disposed on the header of the visor body. A glass layer lines the electro-optic shade.

According to another aspect of the present disclosure, a glass layer is a monolithic glass layer, and the glass layer lines the header.

According to another aspect of the present disclosure, a cover plate is rotatably coupled to a visor body and is rotatable relative to the visor body between an open position, in which the cover plate extends along an electro-optic shade, and a closed position, in which the cover plate extends along a header and covers a mirror.

According to yet another aspect of the present disclosure, a glass layer defines one or more visually-delineated and touch-sensitive button regions that are engageable by a user and are configured to control at least one vehicle setting.

According to Still yet Another Aspect of the Present Disclosure, a header is opaque.

According to yet another aspect of the present disclosure, an electro-optic shade includes a pair of glass substrates, a pair of electrically conductive layers disposed between the pair of glass substrates, and an electrolyte layer disposed between the pair of electrically conductive layers. One of the pair of glass substrates defines at least part of a glass layer.

According to another aspect of the present disclosure, a visor assembly for a vehicle includes a connector arm and a visor body. The visor body includes an opaque header rotatably coupled to the connector arm. The opaque header has an upper side, a lower side, and a first surface. An electro-optic shade extends from the lower side of the opaque header. The electro-optic shade is operable between a clear state and a darkened state and has a second surface. The first surface and the second surface are lined with a glass layer. A cover plate is operably coupled to the visor body and selectively covers a mirror of the visor assembly. At least one light unit is disposed laterally adjacent to the mirror when the cover plate extends along the first surface.

According to another aspect of the present disclosure, a glass layer includes a first glass overlay that lines the first surface and a second glass overlay that lines the second surface. The first glass overlay and the second glass overlay are substantially flush.

According to still another aspect of the present disclosure, first and second glass overlays are portions of a single, monolithic glass layer.

According to yet another aspect of the present disclosure, a visor frame extends along a periphery of each of a header and an electro-optic shade. The visor frame includes an intermediate portion disposed between the header and the electro-optic shade and separating the header and the electro-optic shade.

According to still yet another aspect of the present disclosure, a mirror is disposed on a cover plate.

According to yet another aspect of the present disclosure, a cover plate is rotatable between a closed position, in which the cover plate extends along a header and covers a mirror, and an open position, in which the cover plate extends along an electro-optic shade.

According to another aspect of the present disclosure, a mirror faces toward a visor body in a closed position, and the mirror faces away from the visor body in an open position.

According to yet another aspect of the present disclosure, at least one light unit is disposed within a first surface of a header and is overlaid by a glass layer.

According to still yet another aspect of the present disclosure, at least one light unit is operable between an off state and an illuminated state. The at least one light unit is activated in response to a cover plate being rotated away from a header.

According to another aspect of the present disclosure, a visor assembly for a vehicle includes a visor body configured to be coupled to the vehicle. The visor body includes a header that has an upper side and a lower side. The header includes a mirror configured to face a user with the visor body in a deployed position. An electro-optic shade is coupled to the header proximate the lower side. The electro-optic shade is operable between a clear state and a darkened state. A single, monolithic glass layer lines each of the header and the electro-optic shade. The single, monolithic glass layer has a substantially planar and continuous surface that defines an outer surface of the visor body. The outer surface is configured to face the user in the deployed position of the visor body.

According to still another aspect of the present disclosure, a single, monolithic glass layer is one of a pair of substrates of an electro-optic shade. The electro-optic shade includes a pair of electrically conductive layers disposed between the pair of substrates and an electrolyte layer disposed between the pair of electrically conductive layers.

According to yet another aspect of the present disclosure, a header defines a first arcuate corner, and a mirror has a shape that matches and extends along the first arcuate corner.

According to still another aspect of the present disclosure, a visor assembly includes a cover plate that is rotatably coupled to a visor body and operable between an open position, in which a mirror is viewable by a user with the visor body in a deployed position, and a closed position, in which the mirror is covered by the cover plate. The cover plate defines a second arcuate corner that matches and extends along a first arcuate corner in the closed position.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A dimmable visor assembly, comprising:
a connector arm configured to couple to a vehicle;
a visor body including a header defining a top side of the visor body and an electro-optic shade extending from the header and defining a bottom side of the visor body, wherein the header is rotatably coupled to the connector arm proximate the top side, and wherein the electro-optic shade is operable between a clear state and a darkened state;
a mirror disposed on the header and extending between the top side of the visor body and the electro-optic shade;
one or more light units disposed on the header of the visor body; and
a glass layer lining the electro-optic shade.

2. The dimmable visor assembly of claim 1, wherein the glass layer is a monolithic glass layer, and wherein the glass layer lines the header.

3. The dimmable visor assembly of claim 1, wherein a cover plate is rotatably coupled to the visor body and is rotatable relative to the visor body between an open position, in which the cover plate extends along the electro-optic shade, and a closed position, in which the cover plate extends along the header and covers the mirror.

4. The dimmable visor assembly of claim 1, wherein the glass layer defines one or more visually-delineated and touch-sensitive button regions that are engageable by a user and are configured to control at least one vehicle setting.

5. The dimmable visor assembly of claim 1, wherein the header is opaque.

6. The dimmable visor assembly of claim 1, wherein the electro-optic shade includes a pair of glass substrates, a pair of electrically conductive layers disposed between the pair of glass substrates, and an electrolyte layer disposed between the pair of electrically conductive layers, and wherein one of the pair of glass substrates defines at least part of the glass layer.

7. A visor assembly for a vehicle, comprising:
a connector arm;
a visor body including:
an opaque header rotatably coupled to the connector arm, wherein the opaque header has an upper side, a lower side, and a first surface; and
an electro-optic shade extending from the lower side of the opaque header, wherein the electro-optic shade is operable between a clear state and a darkened state, wherein the electro-optic shade has a second surface, and wherein the first surface and the second surface are lined with a glass layer;
a cover plate operably coupled to the visor body, wherein the cover plate selectively covers a mirror of the visor assembly; and
at least one light unit disposed laterally adjacent to the mirror when the cover plate extends along the first surface.

8. The visor assembly of claim 7, wherein the glass layer includes a first glass overlay lining the first surface and a second glass overlay lining the second surface, and wherein the first glass overlay and the second glass overlay are substantially flush.

9. The visor assembly of claim 8, wherein the first glass overlay and the second glass overlay are portions of a single, monolithic glass layer.

10. The visor assembly of claim 7, wherein a visor frame extends along a periphery of each of the opaque header and the electro-optic shade, and wherein the visor frame includes an intermediate portion disposed between the opaque header and the electro-optic shade, thereby separating the opaque header and the electro-optic shade.

11. The visor assembly of claim 7, wherein the mirror is disposed on the cover plate.

12. The visor assembly of claim 7, wherein the cover plate is rotatable between a closed position, in which the cover plate extends along the opaque header and covers the mirror, and an open position, in which the cover plate extends along the electro-optic shade.

13. The visor assembly of claim 12, wherein the mirror faces toward the visor body in the closed position, and wherein the mirror faces away from the visor body in the open position.

14. The visor assembly of claim 7, wherein the at least one light unit is disposed within the first surface of the opaque header and is overlaid by the glass layer.

15. The visor assembly of claim 14, wherein a transflective coating is disposed between the at least one light unit and the glass layer.

16. The visor assembly of claim 14, wherein the at least one light unit is operable between an off state and an illuminated state, and wherein the at least one light unit is activated in response to the cover plate being rotated away from the opaque header.

17. A visor assembly for a vehicle, including:
a visor body configured to be coupled to the vehicle, the visor body including:
a header having an upper side and a lower side, wherein the header includes a mirror configured to face a user with the visor body in a deployed position;
an electro-optic shade coupled to the header proximate the lower side, wherein the electro-optic shade is operable between a clear state and a darkened state; and
a single, monolithic glass layer lining each of the header and the electro-optic shade, wherein the single, monolithic glass layer has a substantially planar and continuous surface that defines an outer surface of the visor body, the outer surface being configured to face the user in the deployed position of the visor body.

18. The visor assembly of claim 17, wherein the single, monolithic glass layer is one of a pair of substrates of the electro-optic shade, and wherein the electro-optic shade includes a pair of electrically conductive layers disposed between the pair of substrates and an electrolyte layer disposed between the pair of electrically conductive layers.

19. The visor assembly of claim 17, wherein the header defines a first arcuate corner, and wherein the mirror has a shape that matches and extends along the first arcuate corner.

20. The visor assembly of claim 19, further comprising:
a cover plate rotatably coupled to the visor body and operable between an open position, in which the mirror is viewable by a user with the visor body in the deployed position, and a closed position, in which the mirror is covered by the cover plate, wherein the cover plate defines a second arcuate corner that matches and extends along the first arcuate corner in the closed position.
